(19) United States
(12) Patent Application Publication
(10) Pub. No.: US 2016/0166921 A1
(43) Pub. Date: Jun. 16, 2016

(54) INTEGRATING INTERACTIVE GAMES AND VIDEO CALLS

(71) Applicant: Palmwin Information Technology (Shanghai) Co. Ltd., Shanghai (CN)

(72) Inventors: Guoqiang Zhang, Nanjing (CN); Huaichang Zhang, Nanjing (CN); Huanan Ma, Nanjing (CN)

(21) Appl. No.: 14/566,729

(22) Filed: Dec. 11, 2014

(51) Int. Cl. A63F 9/18; A63F 13/537; A63F 13/35

(52) U.S. Cl. CPC A63F 9/183; A63F 13/35; A63F 13/537

(57) ABSTRACT

A solution is provided to enhance user experience by integrating video calls with interactive computer games. A video call with an integrated interactive computer game allows users to enjoy the game play and have more interactions during the video call. Two game players in a video call communicate with each other and play an interactive computer game within the video call. One of the players describes a game scene to the other player according to one or more predefined game rules associated with the game scene. The description is transmitted to the other player in various multimedia formats, e.g., voice, body language and facial expressions. The other player makes a game decision based on the multimedia description.

### BACKGROUND

The disclosure relates generally to Internet based digital media processing, and specifically to integrated interactive games and video calls with mobile computing devices.

Smart handheld devices, such as smart phones and tablet computers, have become increasingly popular. The availability and the bandwidth of network access (for wired and wireless networks) have enabled more communication platforms for digital content consumption and sharing, such as video calls between two parties on their smart phones. However, video call users conventionally do not have access to an interactive computer game that can be played on their smart phones during the video call. Also, conventional interactive games, such as interactive guessing games, are restricted by the physical space occupied by the players, e.g., two players being in the same room.

### SUMMARY

Embodiments of the invention enhance user experience by integrating video calls with interactive computer games. A video call application with an integrated interactive computer game allows users to enjoy the game play and have more interactions during the video call. Adding video function in the course of a computer game play enhances the interactivity of the game and improves the attraction of the computer game to users. On the other hand, adding game function in the process of video calls can increase not only users' interactions but also emotions between users, e.g., willingness to engage a video call.

In one embodiment, a computer-implemented method comprises the following steps. A video call is initiated by a first communication terminal with a second communication terminal. A game channel is established for playing a computer game within the video call between the first communication terminal and the second communication terminal. The computer game has multiple game scenes, each of which has a predefined set of game rules to regulate the game play associated with the game scene. A player describes a game scene in various multimedia formats, e.g., voice, body language, facial expressions and the game scene description data is transmitted to the other player to make a game decision. Based on the multimedia description data of a game scene by a player, the communication terminal associated with the player determines whether the player violates any predefined game rules associated with the game scene and generates a violation alert message for display on the first and second communication terminals once it detects the violation.

In another embodiment, a computer game is played within a video call between a first and a second communication terminals, where game result is determined based on game decisions from both communication terminals. A player of the first communication terminal makes a game decision for a first game scene based on the multimedia description data of the first game scene provided by a player of the second communication terminal. Similarly, a player of the second communication terminal makes a game decision for a second game scene based on the multimedia description data of the second game scene provided by a player of the first communication terminal. The first communication terminal, the second communication terminal, or a game server combines the game decisions from both communication terminals to generate a composite game decision and determines the game result by comparing the composite game decision with a predefined answer.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a computing environment for integrating an interactive computer game and a video call for mobile computing devices according to one embodiment.

FIG. 2 is a block diagram illustrating an example of a computing device for acting as a communication terminal in one embodiment.

FIG. 3 is a block diagram illustrating computer modules of a communication terminal for integrating an interactive computer game and a video call according to one embodiment.

FIG. 4 is a flowchart illustrating a process of playing an interactive computer game in a video call by a user of the communication terminal illustrated in FIG. 3.

FIG. 5A illustrates interactions between two communication terminals of setting up and playing an interactive computer game in a video call according to one embodiment.

FIG. 5B illustrates interactions between two communication terminals of setting up and playing an interactive computer game in a video call according to another embodiment.

FIG. 6A illustrates interactions between two communication terminals of setting up and playing an interactive computer game in a video call, where a game server determines game result based on game decisions from two communication terminals.

FIG. 6B illustrates interactions between two communication terminals of setting up and playing an interactive computer game in a video call, where each communication terminal determines game result based on game decision data from the other communication terminal.

FIG. 7 illustrates interactions between two communication terminals of setting up and playing an interactive computer game in a video call, where a player violates at least one predefined rule associated with a game scene.

FIG. 8 illustrates exemplary user interfaces of communication terminals during an interactive computer game played during a video call.

FIG. 9illustrates exemplary user interfaces of displaying game violation messages on communication terminals during an interactive computer game.

FIG. 10 illustrates exemplary user interfaces of two communication terminals during an interactive computer game, where game result is based on game decisions from the two communication terminals.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

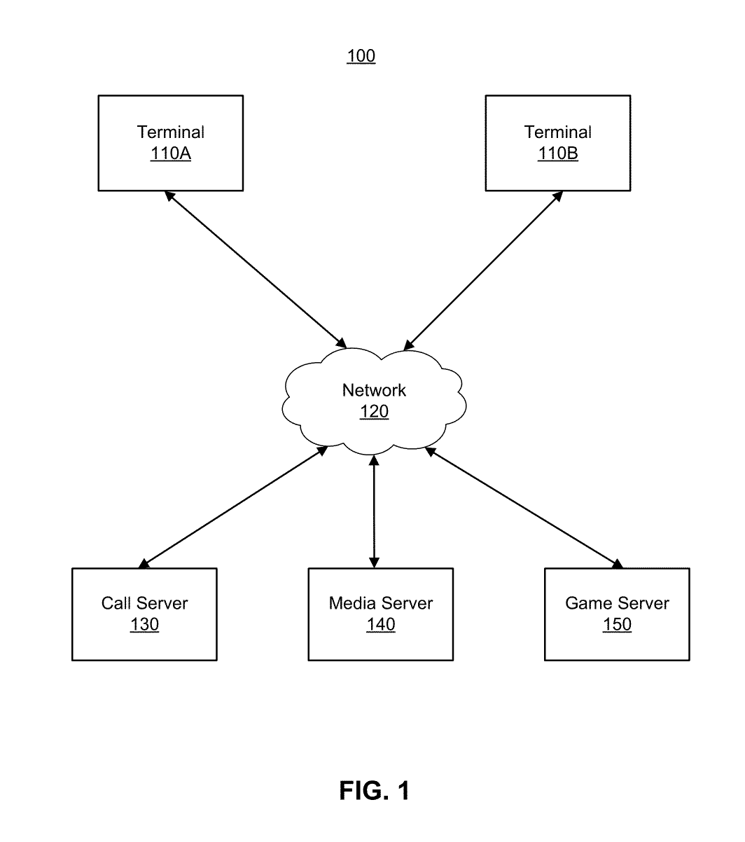

FIG. 1 is a block diagram of a computing environment for integrating an interactive computer game and a video call for mobile computing devices according to one embodiment. The computing environment 100 includes a first communication terminal 110A (also referred to as “first terminal” or “terminal A”) communicates with a second communication terminal 110B (also referred to as “second terminal” or “terminal B”) over a network 120. The computing environment 100 also includes a call server 130, a media server 140 and a game sever 150 to facilitate video call and interactive computer game setup and corresponding interactions between the first communication terminal 110A and the second communication terminal 110B. Only two terminals (110A and 110B), one call server 130, one media server 140 and one game server 150 are shown in FIG.1 in order to simplify and clarify the description. Embodiments of the computing environment 100 can have many communication terminals, call servers 130, media servers 140 and game servers 150 connected to the network 120. Likewise, the functions performed by the various entities of

FIG.1 may differ in different embodiments.

In one embodiment, a user of the first terminal 110A plays a video call to a user of the second terminal 110B. Once the call is set up and a game channel is established, the user of the first terminal 110A and the user of the second terminal 110B play an interactive computer game, such as a guessing game of an object (e.g., hamburger), while engaging in the video call. A computer game has one or more game scenes and a set of predefined rules associated with each game scene. In one embodiment, a game scene of a computer game is a spatial representation of a graphical scene of the computer game, e.g., a two-dimensional ship on a white background. A player associated with a communication terminal, e.g., 110A, describes the game scenes and communicates the game scene description data with the other player of the other communication terminal, e.g., 110B. Based on the game scene description data, the communication terminals make one or more game decisions, e.g., name of the object being guessed. The communication terminal determines whether a user violates any predefined rule associated with a game scene based on the user's game scene description data and terminates the computer game in response to a violation.

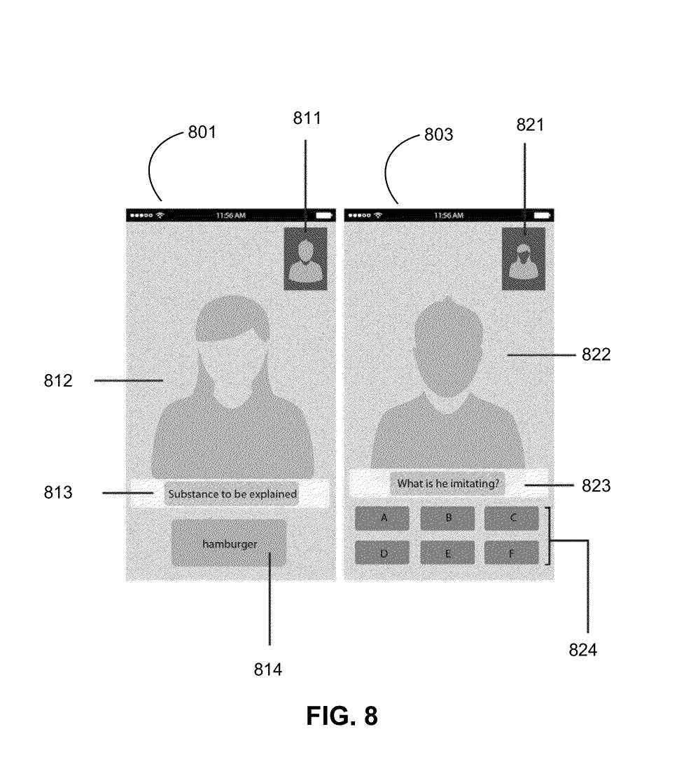

Turning now to FIG. 8, FIG. 8 illustrates exemplary user interfaces of two communication terminals, 801 and 803, in an interactive computer game played during a video call. In this example, a video call is initiated between two players 811 and 821, who play an interactive guessing game of an object during the video call using their smart phones. The object to be guessed in this example is “hamburger” 814, which can be shown in picture or textual description to player 811. Player 811 can describe the object in a variety of ways, including voice, body language or facial expressions. The description 813 of the object through the voice, body language or facial expressions of player 811 is displayed in the display 822 of the smart phone of player 821, where player 821 is to guess the object described by player 811. In one embodiment, player 821 receives some information regarding the object to be guessed (e.g., “what is he imitating” 823) and player 821 is presented with one or more answer choices 824 to the question (e.g., answer choices A, B, C, D, E and F, one of which is a correct answer). Responsive to receiving the answer choice selected by player 821, the smart phone of player 811 compares the answer with a predefined answer. If player 821 makes a correct guess, a confirmation message is displayed on both smart phones of players 811 and 821 and both players 811 and 821 are presented with next game scene. If player 821 makes a wrong guess, both players 811 and 821 may be presented with the same or different examples of hamburger and can attempt to make another description of the hamburger for player 821 to guess, or player 821 is presented with next game scene.

The call server 130 is a computer server that facilitates video communication among multiple communication terminals. In one embodiment, the call server 130 processes data associated with video calls and network connections, such as registration of communication terminals of a video call, transmission of call requests, call acknowledgements and requests to end video calls. Other embodiments of the call server 130 may include additional and/or different functions than described herein

The media server 140 is a computer server that processes the audio or video streams associated with video communication and computer games. In one embodiment, the media server 140 is dedicated to receiving multimedia description data from one terminal and delivering the multimedia description data to another terminal. The media server 140 is further configured to perform various functions associated with video communication, such as recording, encoding, decoding, storing and playing back. Other embodiments of the media server 140 include additional and/or different functions than described herein.

The game server 150 is a computer server that coordinates game setup and game playing during a video call. In one embodiment, the game server 150 stores game scene data, a set of rules associated with each game scene, game decisions/answers and game result. For an interactive computer game, such as guessing game of an object (hamburger), played by two terminals, e.g., 110A and 110B, the game server 150 distributes one game scene of the computer game and the associated rules at a time to one or both terminals. The game server 150 also receives game decision data from the terminals, such as the identification of the object to be guessed. The game server 150 may store a set of predefined game answers associated with a computer game and compare the game answers with the game decision data received from one or more terminals. The game server 150 determines the game result, e.g., whether a player associated with a terminal has correctly guessed the object to be identified by the game scene description data received from the other terminal. The game server 150 distributes the game result to the terminals. Alternatively, a terminal may store a set of predefined game answers and determines the game result.

In another embodiment, the game server 150 receives a game description violation alert from a terminal and sends the violation alert to the other terminal. The game server 150 may accordingly terminate the current game scene following the violation alert and start a new game scene.

The network 120 enables communications among the first communication terminal 110A, the second communication terminal 110B, the call server 130, the media server 140 and the game server 150 and can comprise the Internet as well as wireless communications networks. In one embodiment, the network 120 uses standard communications technologies and/or protocols. Thus, the network 120 can include links using technologies such as Ethernet, 802.11, worldwide interoperability for microwave access (WiMAX), 4G, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

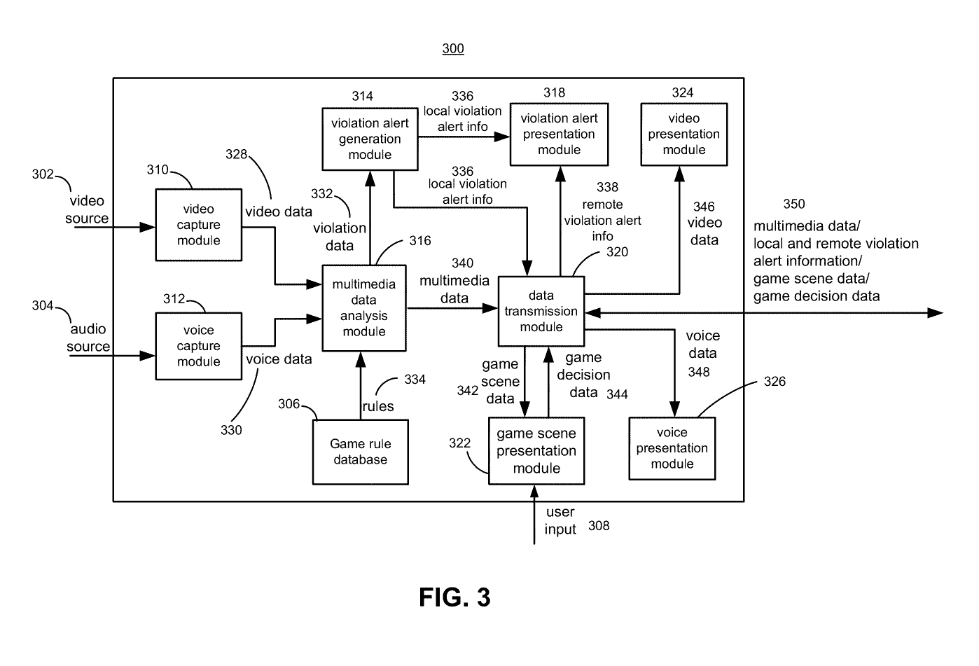

A communication terminal, e.g., the first terminal 110A or the second terminal 110B, is an electronic device used by a user to perform functions such as communicating and consuming digital media content including video chat, executing software applications, browsing websites hosted by web servers on the network 120 and interacting with the call server 130, the media server 140 and the game sever 150. A communication terminal may be a smart phone, or a tablet, notebook, or desktop computer or a dedicated game console. The communication terminal includes and/or interfaces with a display device on which the user may view the video files and other digital content. In addition, the communication terminal provides a user interface (UI), such as physical and/or on-screen buttons, with which the user may interact with the communication terminal to perform functions such as video chatting, playing a video game, selecting digital content, downloading samples of digital content, and purchasing digital content. An exemplary communication terminal is described in more detail below with reference to FIG.3.

### Computing System Architecture

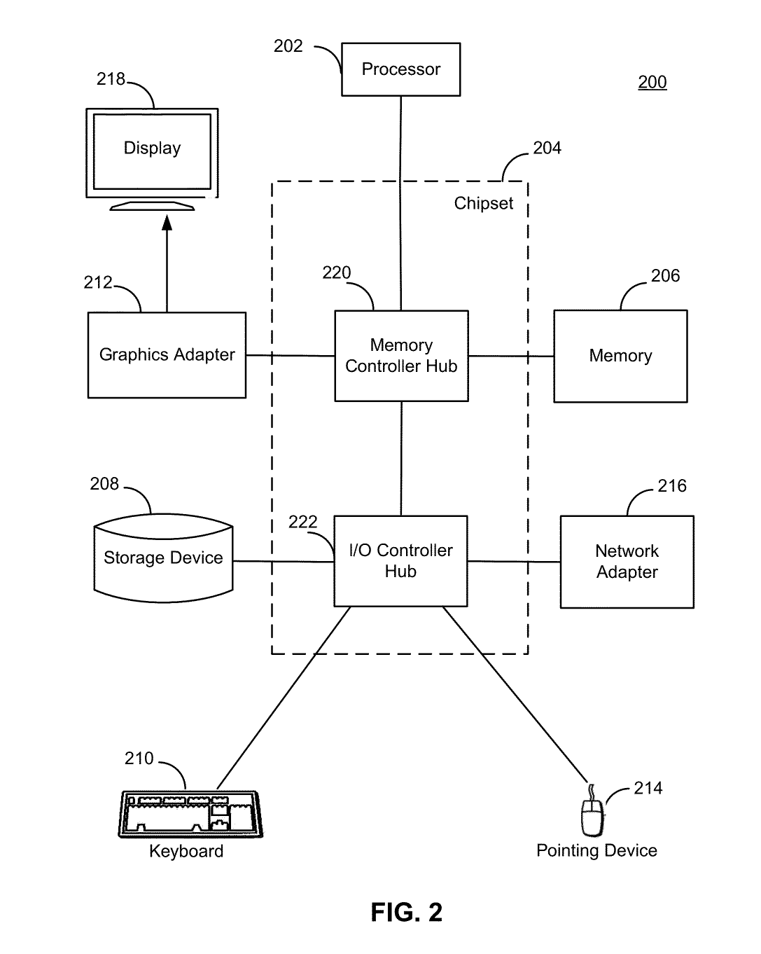

The entities shown in FIG. 1 are implemented using one or more computers. FIG. 2 is a high-level block diagram of a computer 200 for acting as the first terminal 110A, the second terminal 110B, the call server 130, the media server 140 and/or the game server 150. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 120.

As is known in the art, a computer 200 can have different and/or other components than those shown in FIG. 2. In one embodiment, the display 218 receives visual input generated by the processor 202. For example, the touch sensitive surface of the display 218 detects the touch operation on or near the touch sensitive surface and transmits the touch operation to the processor 202 to determine a type of the touch event. The processor 202 provides, according to the type of the touch event, a corresponding visual output to the display 218 for display.

The computer 200 functioning as the first communication terminal 110A or the second communication terminal 110B may further include a sensor, such as an optical sensor and a motion sensor. The first communication terminal 110A or the second communication terminal 110B may also have an audio circuit, a loudspeaker, and a microphone to provide audio interfaces between a user and the terminal. A WiFi module can be included in the first communication terminal 110A or the second communication terminal 110B to provide wireless Internet access for the user, who can send or receive emails, browse web pages and access streaming media.

In addition, the computer 200 can lack certain illustrated components. For example, the computers acting as the call server 130, the media server 140 or the game server 150 can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

### Intregated Interactive Computer Games and Video Calls

FIG. 3 is a block diagram illustrating a communication terminal, e.g., the first communication terminal 110A or the second communication terminal 110B, for integrating interactive computer games and video calls according to one embodiment. For simplicity of illustration, the modules illustrated in FIG. 3 are for the first communication terminal 110A used by a user of a video call with a user of the second communication terminal 110B.The first communication terminal 110A is a smart handheld device such as a smart phone. The second communication terminal 110B is used by a user to receive a video call from the user of the first communication terminal 110A. The second communication terminal 110B may contain the same modules and/or additional or different modules from the ones described below. In the embodiment shown in FIG. 3, the first communication terminal 110A has a video capture module 310, a voice capture module 312, a violation alert generation module 314, a multimedia data analysis module 316, a violation alert presentation module 318, a data transmission module 320, a game scene presentation module 322, a video presentation module 324 and a voice presentation module 326. Other embodiments may contain different functional modules and different number of modules.

The video capture module 310, e.g., an embedded digital camera of a smart phone, captures video data 328 from a video source 302, e.g., a player mimicking an object to be guessed. The video data 328 includes one or more video frames/pictures of the video source 302. The voice capture module 312, e.g., an embedded microphone of a smart phone, records voice data 330 of an audio source 304, e.g., voices made by a user of the first terminal describing a game scene. The video data 328 and the voice data 330 are received and processed by the multimedia data analysis module 316.

The multimedia data analysis module 316 receives the video data 328 from the video capture module 310 and the voice data 330 from the voice capture module 312 and analyzes the received video data 328 and the voice data 330 based on the rules 334 stored in a game rule database 306. In one embodiment, the rules 334 are associated with a computer game and are predefined by game developers of the computer game. The game rules can be game scene based, i.e., each game scene of a computer game has its own rule specifying conditions a player violates any game rule associated the game scene. Each rule is parsed by the multimedia data analysis module to monitor the user's game scene description to detect possible violations. Each rule can include instructions and parameters that help the monitoring process. For example, it can instruct the program to be incurred by the multimedia data analysis module, and the parameters passed to that program. The multimedia data analysis module 316 analyzes the video data 328 to determine whether the player associated with the video data 328 violates any predefined game rules. For example, the multimedia data analysis module 316 analyzes the video data 328 capturing a player showing an image of “hamburger” and determines that the player violates the game rule by providing a direct clue of the object being guessed to the other player. Similarly, the multimedia data analysis module 316 analyzes the voice data 330 recording a player pronouncing the word “hamburger” and determines that the player violates the game rule by providing a direct clue of the object being guessed. Any existing pattern recognition in video processing and voice recognition schemes known to those of ordinary skill in the art can be used by the multimedia data analysis module 316 for the analysis.

Based on the analysis, the multimedia data analysis module 316 generates violation data 332 and multimedia data 340 for further processing by other modules. In one embodiment, the violation data 332 identifies the type of multimedia data, e.g., video data 328 or voice data 330,which contributes to the violation, the player who engaged in the violation and a particular game rule being violated. The violation alert generation module 314 receives the violation data 332 and generates local violation alert information 336. In one embodiment, the local violation alert information 336 describes the type of violation and a particular rule being violated, and the local violation alert information 336 is further processed by the violation alert presentation module 318.

The violation alert presentation module 318 receives violation alert information, e.g., the local violation alert information 336 from the first terminal 110A or the remote violation alert information 338 from the second terminal 110B, and presents the violation alert information to the first terminal 110A. In one embodiment, the violation alert presentation module 318 presents the violation alert in text. In another embodiment, the violation alert presentation module 318 presents the violation alert in other media formats, such as voice message, animation, video message and combination of two or more media formats.

The multimedia data analysis module 316 also generates multimedia data 340 for further processing by the data transmission module 320. In one embodiment, the multimedia data 340 of a game scene comprises video data 346 and voice data 348, which describe the game scene. The video data 346 captures the player's body language and facial expression of a game scene in one or more video frames by a video capturing device, e.g., the digital camera of the first terminal 110A. Exemplary video frames include images of a player of the first terminal 110A imitating an object to be guessed by a player of the second terminal 110B. The voice data 348 records sounds/voices associated with a game scene by a voice recording device, e.g., the microphone of the first terminal 110A. Exemplary voice data includes voices of a player of the first terminal 110A describing an object to be guessed by a player of the second terminal 110B.

The data transmission module 320 transmits a variety of data associated with a computer game to corresponding modules for further processing. In one embodiment, the data transmission module 320 receives data associated with a computer game, which is locally generated by the local communication terminal, i.e., the first terminal 110A. The locally generated data includes the multimedia data 340, local violation alert information 336 and game decision data 344. In another embodiment, the data transmission module 320 receives data 350 associated with a computer game, which is remotely generated by a remote communication terminal or a game server, i.e., the second terminal 110B or the game server 150. The remotely generated data 350 can be multimedia data (similar to the local multimedia data 340), the remote violation alert information (similar to the local violation alert information 336), game scene data (similar to the game scene data 324) and game decision data (similar to the game decision data 344). For simplicity, the various types of remote data are generally referenced by 350 in FIG. 3.

Responsive to the multimedia data, the data transmission module320 transmits the locally generated multimedia data to the other terminal, and receives the multimedia data generated by the other terminal, identifies the video data 346 and the voice data 348 and forwards the identified data to perspective modules for further processing. In one embodiment, the data transmission module 320 forwards the video data 346 to the video presentation module 324 for display on the first terminal 110A. Similarly, the data transmission module 320 forwards the voice data 348 to the voice presentation module 326 for playing back the voice on the first terminal 110A. The data transmission module 320 transmits locally generated multimedia data 340 through the network 120 to the other terminal 110B if the multimedia data does not violate the predefined rules.

Responsive to violation alert information, the data transmission module 320 forwards the violation alert information to the violation alert presentation module 318 of the local terminal to present the alert information locally, and transmits the local violation alert information through the network 120 to the remote terminal 110B. The data transmission module 320 also receives the remote violation alert information generated by the other terminal and forwards it to the violation alert presentation module 318 of the local terminal to present the alert information.

Responsive to the game decision data 344 locally generated based on the user input 308, e.g., an answer choice selected by the player illustrated in FIG. 8 above, the data transmission module 320 transmits the game decision data 344 to the remote terminal or the game server 150 to determine the game result. Responsive to the remote game decision data 150 received from the remote terminal, the data transmission module 320 forwards s the remote game decision data to a game result module (not shown in FIG. 3) to determine the game result. Responsive to the game scene data, the data transmission module 320 receives the game scene data from the game server 150 and forwards it to game scene presentation module 322 for display.

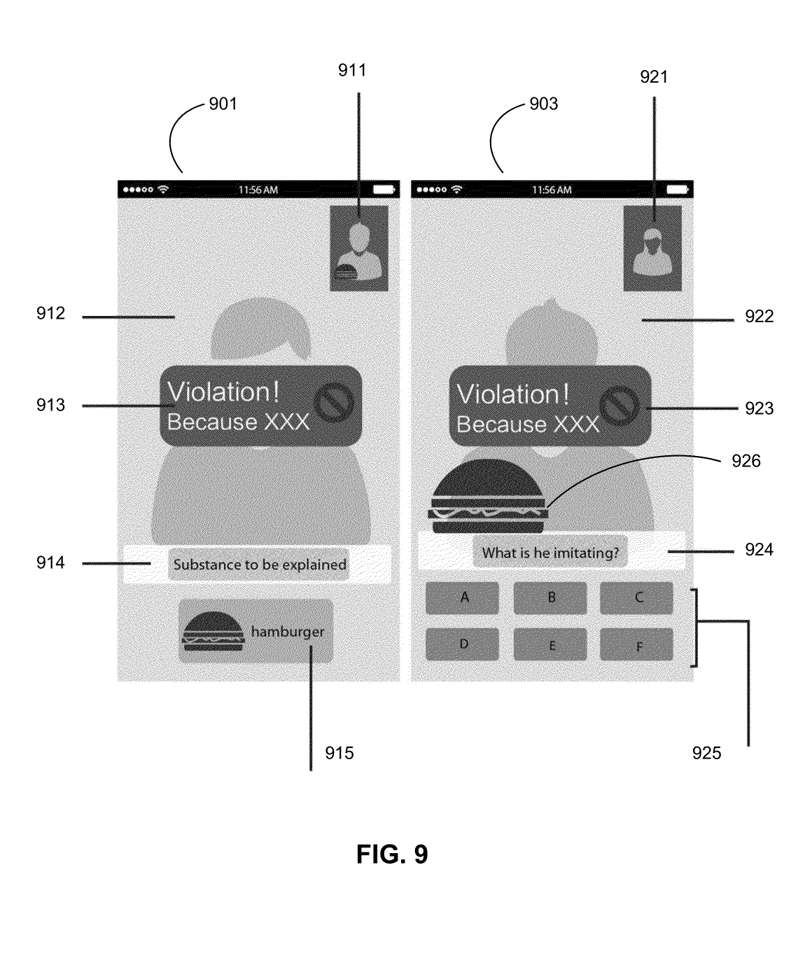

Turning now to FIG. 9, FIG. 9 illustrates exemplary user interfaces of displaying game violation messages on communication terminals 901 and 903 during an interactive computer game. Similar to the computing environment illustrated in FIG. 8, player 911 and player 921 play an interactive guessing game, where player 911 is shown a picture of hamburger 915 (the object to be guessed by player 921 based on the multimedia description data of hamburger from player 911). Different from the situation illustrated in FIG. 8, player 911 violates the predefined game rule associated with the game scene by showing a picture of a hamburger 926 to player 921. The picture of the hamburger 926 is captured by the embedded camera of the first terminal 901 and the picture 926 is transmitted to the second terminal 903 as part of the multimedia data generated by terminal 901. The multimedia data analysis module 316 of the first terminal 901 executes an image recognition program and analyzes the picture of hamburger 926 against the predefined rules associated with the game scene, which describe various regulations on how to play the computer game, e.g., showing an image of an object to be guessed or pronouncing name of the object to be guessed being prohibited. The first terminal 901 determines that player 911 violates the predefined rules and generates a violation alert message 913 for display on the first terminal 901. In the example illustrated in FIG. 9, the violation alert message 913 is also transmitted to and displayed at the second terminal 903. Upon the detection of game rule violation, the first terminal 901 may present another game scene for players 911 and 921 to continue playing the computer game or terminate the computer game.

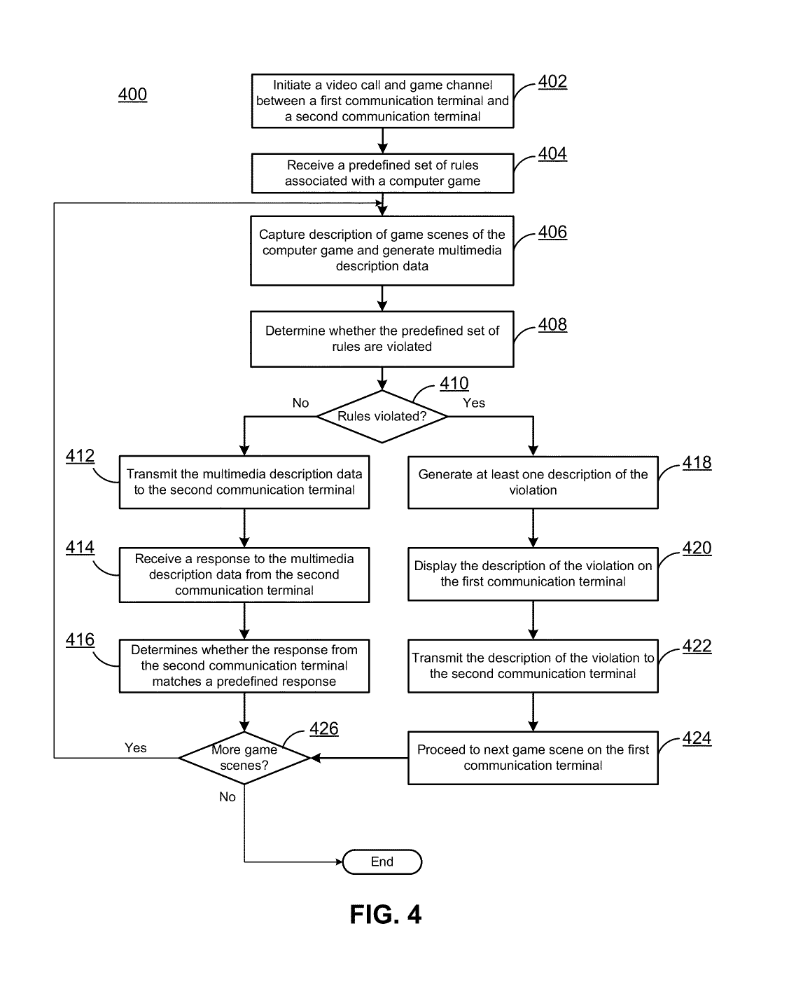

FIG. 4 is a flowchart illustrating a process of two game players playing an interactive computer game in a video call. Initially, a player using the first communication terminal 110A, e.g., a mobile phone, initiates 402 a video call and establishes a game channel to play the interactive computer game between the first communication terminal 110A and a second communication terminal 110B. At step 404, the first communication terminal 110A receives a predefined set of rules associated with the interactive computer game. The predefined set of rules associated with the interactive computer game describes various conditions, according to which a user plays the computer game. In one embodiment, each game scene of the interactive computer game has at least one of the predefined set of rules associated with the game scene.

The first communication terminal 110A captures 406 description of game scenes of the computer game provided by the player of the first communication terminal 110A and generates multimedia description data. The description of the game scenes of the computer game can be in a form of video data, voice data or combination of both. In one embodiment, the multimedia description data includes video frames showing body language and/or facial expressions of the player of the first communication terminal 110A and recorded voices of the player of the first communication terminal 110A while describing the game scenes. At step 408, the first communication terminal 110A determines whether the player of the first communication terminal 110A violates any predefined set of rules associated with the computer game.

Responsive to no rule being violated, the first communication terminal 110A transmits 412 the multimedia description data to the second communication terminal 110B, where the second communication terminal 110B makes a response to the multimedia description data, e.g., selecting an answer from a set of predefined answers. At step4l4, the first communication terminal 110A receives the response to the multimedia description data from the second communication terminal 110B and determines 416 whether the response from the second communication terminal 110B matches a predefined response. Responsive to a match being found, the first communication terminal 110A may display the determination on the first communication terminal 110A and transmit the determination to the second communication terminal 110B for display. The first communication terminal 110A checks 426 whether there are more game scenes to play with, and if there are more game scenes, the first communication terminal 110A repeats the steps 406-416.

Responsive to at least one rule being violated, the first communication terminal 110A generates 418 at least one description of the violation and displays 420 the description of the violation on the first communication terminal 110A. At step4 22, the first communication terminal 110A transmits the description of the violation to the second communication terminal 110B for display. At step 424, the first communication terminal 110A proceeds to next game scene of the computer game.

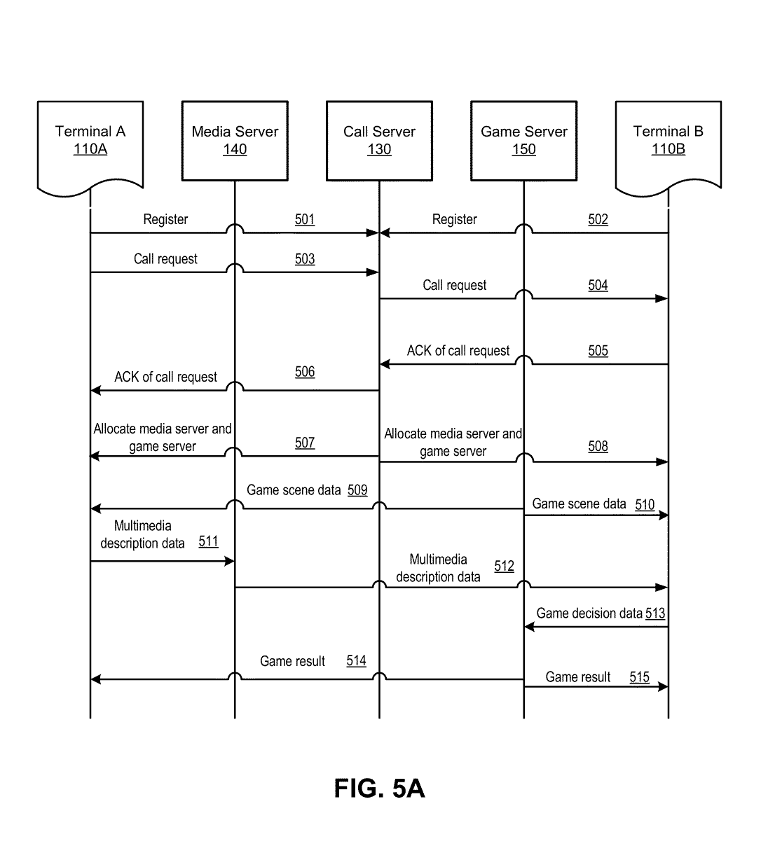

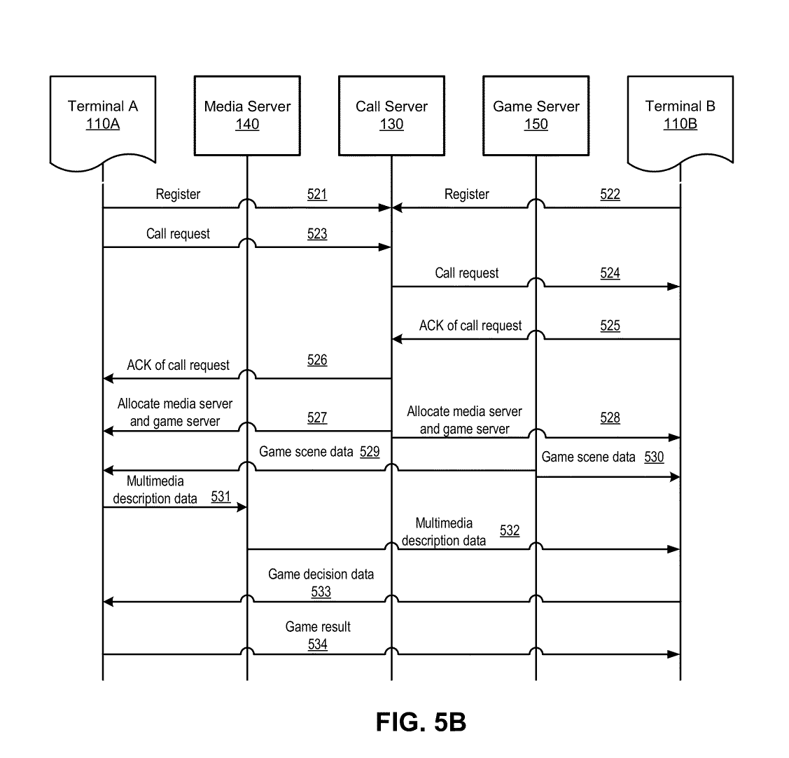

FIG. 5A illustrates interactions between two communication terminals, 110A and 110B, of setting up and playing an interactive computer game in a video call according to one embodiment. The media server 140, the call server 150, and the game server 130 facilitate in the game setup and game play and provide various supporting functions as follows. Initially, the terminal A 110A registers 501 with the call server 130 to place a video call with the terminal B 110B, and the terminal B 110B registers 502 with the call server 130 to receive the call. The terminal A 110A sends 503 a call request to the call server 130, which relays 504 the call request to the terminal B 110B. Upon receiving the call request at the terminal B 110B from the call server 130, the terminal B 110B sends 505 an acknowledgement of the call request to the call server 130, which relays 506 the acknowledgement to the terminal A 110A.The call server allocates a media server and a game server to the terminal A (step 507)and the terminal B (step 508), e.g., by sending the Internet address of the media server 140 and the Internet address of the game server 150 to the two terminals 110A and 110B.

The game server 150 sends the game scene data to the terminal A 110A (step 509)and the terminal B 110B(step 510), where the game scene data describes a game scene of the computer game, e.g., a restaurant menu having multiple menu items. The game scene is displayed on the terminal A 110A and the terminal B 110B. The terminal A 110A captures 511 the multimedia description of the game scene by a player, including body movements, facial expressions, and/or voices, and sends 511 the multimedia description data to the media server 140, which relays 512 the multimedia description data to the terminal B 110B. The player of the terminal B 110B makes a game decision (e.g., an answer selection illustrated in FIG. 8) based on the received multimedia description data and sends 513 the game decision data to the game server 150. The game server 150 compares the game decision data from the terminal B 110B with a predefined answer stored at the game server 150 and determines the game result based on the comparison, e.g., whether the player of the terminal B 110B has correctly guessed object described by the multimedia description data received from the terminal A 110A. The game server 150 forwards the game result to the terminal A 110A (step 514) and the terminal B 110B (step 515), respectively.

Alternatively, steps of transmitting the game decision data, the game result determination, and forwarding the game result, e.g., steps 513, 514, and 515 illustrated in FIG. 5A, may be completed without assistance from the game server 150; in other words, the steps of 513, 514 and 515 may be performed between the terminal A 101A and the terminal B 101B. FIG. 5B illustrates interactions between two communication terminals of setting up and playing an interactive game in a video call according to an alternative embodiment. In FIG. 5B, the steps of video call initiation, media server and game server allocation, game scene data distribution and multimedia description data transmission (i.e., steps 521 to 532)are identical or similar to the steps of 501 to 512 illustrated in FIG. 5A, and the corresponding descriptions are omitted for simplicity.

Different from the embodiment illustrated in FIG. 5A, the alternative embodiment illustrated in FIG. 5B stores the predefined answer associated with a game scene at the terminal A 101A, rather than at the game server 150 as in the embodiment in FIG. 5A. Different from the steps 513 to 515 of FIG. 5A, the terminal B 101B sends 533 the game decision data directly to the terminal A 110A after making the game decision based on the multimedia description data 532 received from the terminal A 110A. The terminal A 101A compares the game decision data from the terminal B 110B with the locally stored predefined answer and determines the game result based on the comparison. The game result is forwarded 534 to the terminal B 101B by the terminal A 101A.

Some complex computer games, e.g., complex guessing games, often require two or more players to work together to find an answer to a question posted by a computer game. For this type of computer games, each player describes a game scene of a computer game and communicates the description of their respective game scene to the other player. Each player makes a game decision for a game scene based on the game scene description data from the other player. A game server or a communication terminal of one of the players combines the game decisions from both players to generate a composite game decision and compares the composite game decision with a predefined answer to determine the game result.

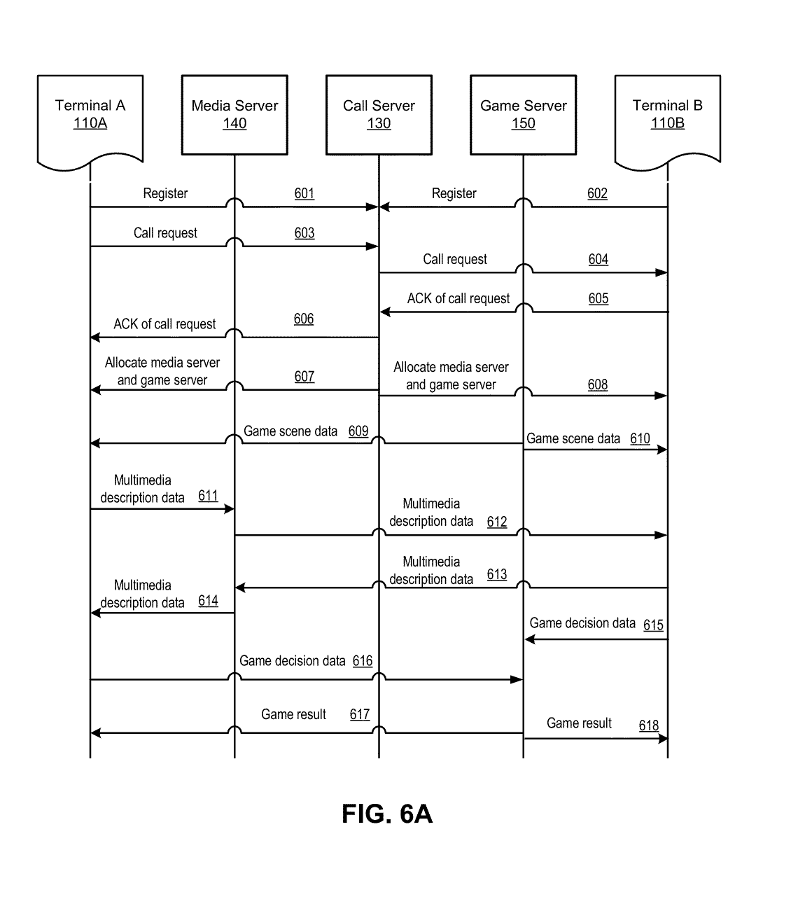

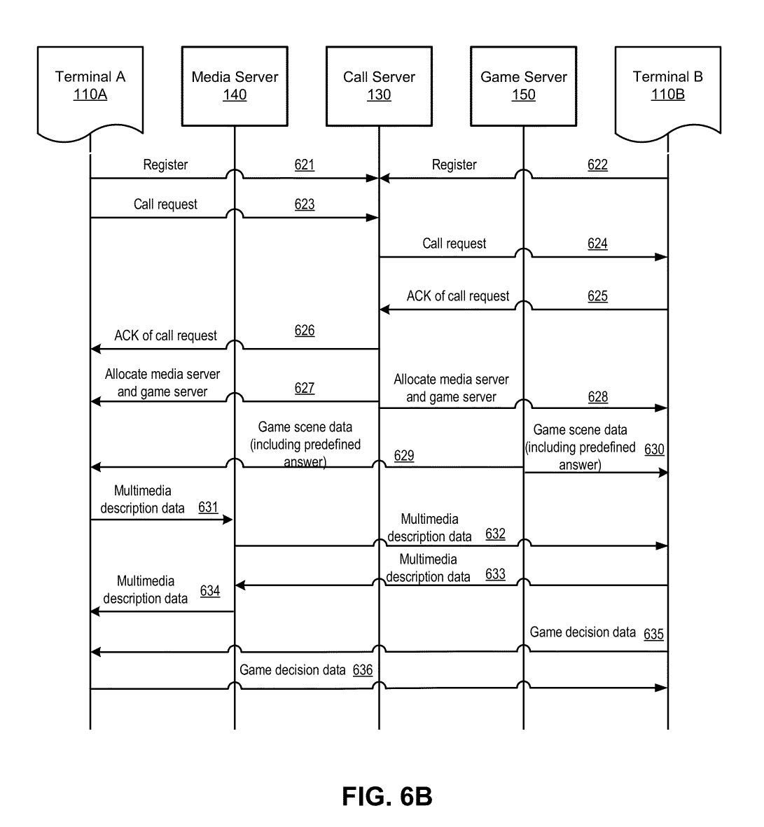

FIG. 6A illustrates interactions between two communication terminals of setting up and playing an interactive game in a video call, where a game server (e.g., the game server 150) determines game result based on game decisions from two communication terminals. In this embodiment, the players of the terminals 101A and 101B work together to find the answer to a question posted by a computer game. Similar to the embodiment illustrated in FIG. 5A, the steps of video call initiation, media server and game server allocation and game scene data distribution (i.e., steps 601 to 610) are identical or similar to the steps of 501 to 510, and the corresponding descriptions are omitted for simplicity.

Different from the embodiments illustrated in FIG. 5A and FIG. 5B, where one player provides game scene description data to another player, who makes a game decision accordingly, in the embodiment illustrated in FIG. 6A, the terminal A 110A captures the multimedia description of a first game scene of the computer game by the player associated with the terminal A 110A, including body movements, facial expressions, and/or voices, and sends 611 the multimedia description data to the media server 140, which relays 612 the multimedia description data associated with the first game scene to the terminal B 110B. Concurrently, the terminal B 110B captures the multimedia description of a second game scene of the same computer game by the player associated with the terminal B 110B, and sends 613 the multimedia description data to the media server 140, which relays 614 the multimedia description data associated with the second game scene to the terminal A 110A. It is noted that, for simplicity of illustration, the FIG. 6 illustrates an example where the steps 611 and 612 are executed before the steps 613 and 614. An ordinarily skilled person in the art understands that the embodiments of the invention are not limited thereto because the steps of 611/612 and the steps of 613/614 can occur concurrently.

Each player makes a game decision based on the received multimedia data from the other player as well as the player's understanding of the game scene locally presented to the player. For example, the player of the terminal B 110B makes a game decision based on the game scene description data received from the terminal A 110A and sends 615 the game decision data to the game server 150; the player of the terminal A 110A makes a game decision based on the game scene description data received from the terminal B 110B and sends 616 the game decision data to the game server 150. The game server 150 combines the game decision data from the terminal A 101A and the terminal B 101B to generate a composite response. The game server 150 compares the composite response with a predefined answer stored at the game server 150. The game server 150 determines a game result based on the comparison and sends the game result to the terminal A 101A (step 617) and the terminal B 101B (step 618), respectively.

FIG. 6B illustrates interactions between two communication terminals of setting up and playing an interactive game in a video call, where each communication terminal determines game result based on game decision data from the other communication terminal. Different from the embodiment illustrated in FIG. 6A, where the game server 150 determines the game result based on the game decisions made by the two terminals, 110A and 110B, the player of the terminal B 110B makes a game decision based on the multimedia description data 632 received from the terminal A 110A and the game decision data is sent 635 to the terminal A 110A. Similarly, the player of the terminal A 110A makes a game decision based on the multimedia description data 634 received from the terminal B 110B and the game decision data is sent 636 to the terminal B 110B. Either one of the terminals, 110A and 110B, can combine its own game decision data with the game decision data from the other terminal to generate a composite response and determine the game result by comparing the composite response with a locally stored predefined answer.

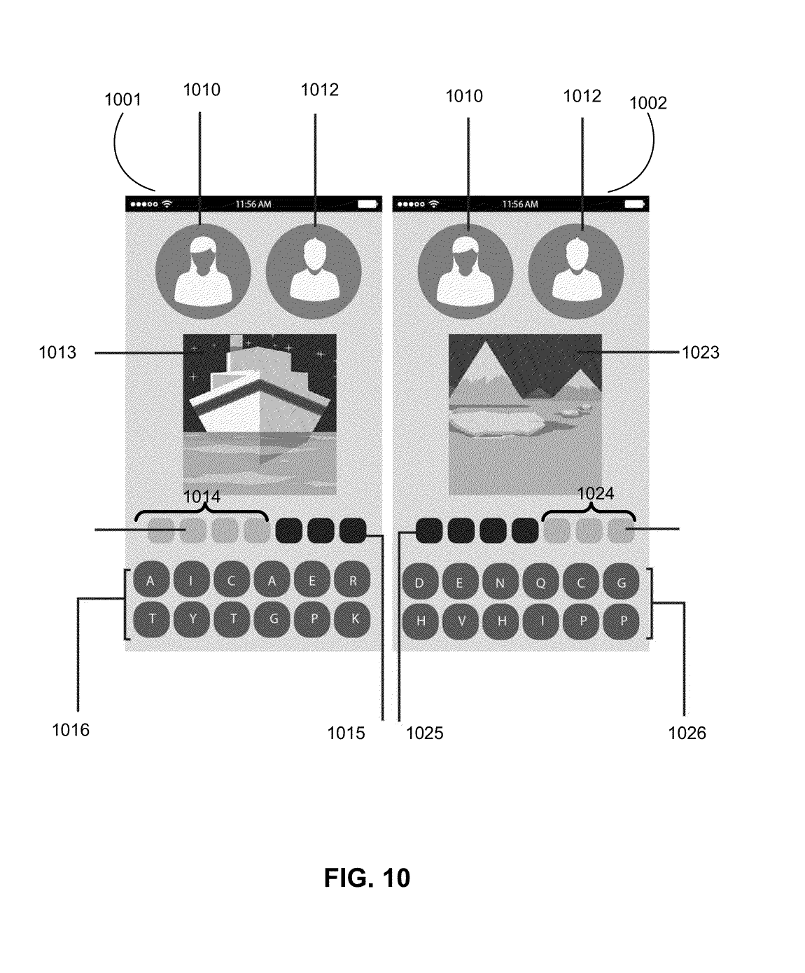

To further illustrate the embodiments described with reference to FIG. 6A and FIG. 6B, FIG. 10 illustrates exemplary user interfaces of two communication terminals during an interactive computer game, where game result is based on game decisions from the two communication terminals. In this example, two players 1010 and 1012 play an interactive guessing game, i.e., guessing the name of “TITANIC” together. The left side of the figure shows the smart phone interface 1001 of player 1012 and the right side of the figure shows the smart phone interface 1002 of player 1010. Player 1012 is presented with a game scene 1013 of the computer game, which is an image of a ship; player 1010 is presented with a game scene 1023 of the same computer game, which is an image of an ice berg. Player 1012 needs to make a game decision based on the game scene description of the game scene 1023 (i.e., the ice berg) provided by player 1010; player 1010 needs to make a game decision based on the game scene description of the game scene 1013 (i.e., the ship) provided by player 1012. The game decision of player 1012 comprises a four-letter word. In this example, the four letters to be guessed are indicated by the four gray squares 1014, and the four letters can be selected from the available letters 1016. The correct answer for player 1012 is “TITA.” Similarly, the game decision of player 1010 comprises a three-letter word. In this example, the three letters to be guessed are indicated by the three gray squares 1024, and the three letters can be selected from the available letters 1026. The correct answer for player 1010 is “NIC.” Each player, 1010 and 1012, or the game server 150, can determine the game result, i.e., “TITANIC,” by combining his/her own game decision with the game decision from the other player.

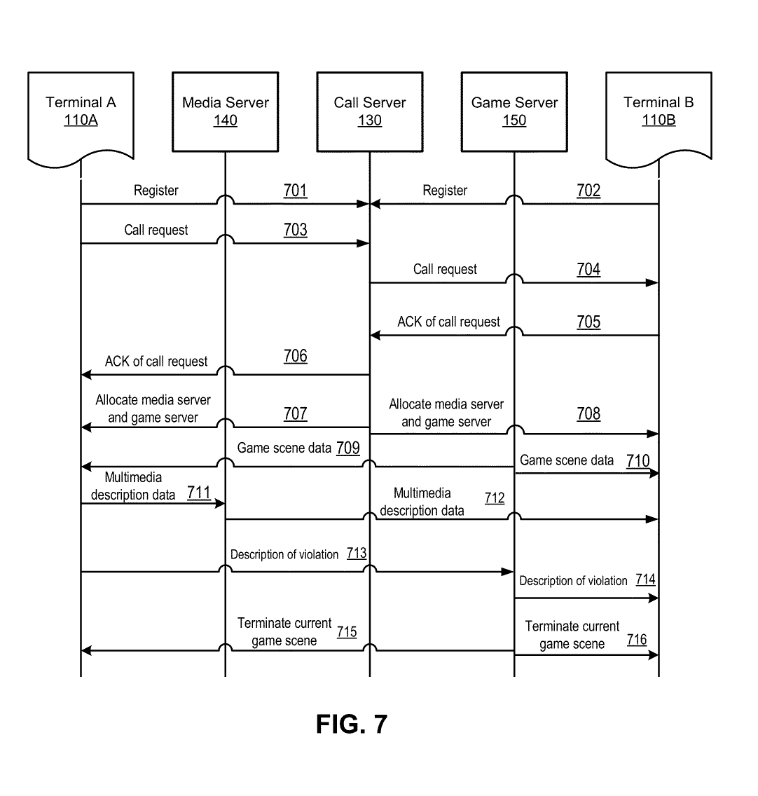

FIG. 7 illustrates interactions between two communication terminals of setting up and playing an interactive game in a video call, where a player violates at least one predefined rule associated with a game scene. Upon completion of video call setup and game channel establishment as described above with references to FIGS. 5A-5B, the terminal A 110A transmits 711 the multimedia description data to the media server 140, which relays 712 the multimedia description data to the terminal B 110B. The multimedia data analysis module 316 determines whether the player associated with the terminal A 110A violates any predefined game rule by analyzing the multimedia description data with the predefined game rules. Responsive to the player violating a predefined game rule, e.g., showing an image of the object being guessed to the other player, the terminal A 110A generates a violation alert message describing the violation and transmits 713 the violation alert message to the game server 150, which sends to the terminal B 110B for display. The game server 150 terminates the current game scene on both terminals.

### General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method, comprising:
initiating, by a first communication terminal, a video call between the first communication terminal and a second communication terminal;
receiving a predefined set of rules associated with a computer game played between a user of the first communication terminal and a user of the second communication terminal;
capturing description of a plurality of game scenes of the computer game provided by the user of the first communication terminal;
generating multimedia description data at the first communication terminal based on the description of the plurality of game scenes; and
determining whether the user of the first communication terminal violates at least one of the predefined set of rules in response to the generated multimedia description data.

2. The method of claim 1, wherein each of the plurality of game scenes has at least one associated predefined rule selected from the predefined set of rules associated with the computer game.

3. The method of claim 1, further comprising establishing a game channel between the first communication terminal and the second communication terminal, the game channel associated with the video call between the first communication terminal and the second communication terminal.

4. The method of claim 1, further comprising:
responsive to a determination that the user of the first communication terminal does not violate the predefined set of rules:
transmitting the multimedia description data to the second communication terminal;
receiving a response to the multimedia description data from the second communication terminal; and
determining whether the response from the second communication terminal matches a predefined response, the predefined response describing an object of the computer game.

5. The method of claim 4, further comprising:
responsive to a determination that the response matches the predefined response, displaying the determination on the first communication terminal.

6. The method of claim 1, further comprising:
responsive to a determination that the user of the first communication terminal violates the predefined set of rules:
generating at least one description of the violation;
displaying the description of the violation on the first communication terminal;
transmitting the description of the violation to the second communication terminal, wherein the second communication terminal is adapted to display the description of the violation on the second communication terminal; and
terminating the computer game on the first communication terminal.

7. The method of claim 1, wherein the predefined set of rules associated with a computer game describes a plurality of conditions under which a user playing the computer game violates the predefined set of rules.

8. The method of claim 1, wherein capturing description of a plurality of game scenes of the computer game provided by the user of the first communication terminal comprises:
capturing one or more body movements of the user of the first communication terminal;
capturing one or more facial expressions of the user of the first communication terminal; and
recording voices of the first communication terminal;
wherein the captured body movements, facial expressions and voices of the user of the first communication terminal are associated with the computer game.

9. The method of claim 1, wherein violations of the predefined set of rules comprises at least one of the following:
showing a picture of an object of the computer game;
showing an real substance of an object of the computer game; and
pronouncing the name of an object of the computer game.

10. The method of claim 1, further comprising:
generating a response to a first scene of the computer game by the user of the first communication terminal;
receiving a response to a second scene of the computer game from the user of the second communication terminal;
combining the response from the user of the first communication terminal and the response from the user of the second communication terminal to generate a composite response to the computer game; and
determining whether the composite response to the computer game matches a predefined response to the computer game.

11. The method of claim 1, further comprising:
generating a response to a first scene of the computer game by the user of the first communication terminal; and
providing the response to the first scene to a game server, wherein the game server is adapted to:
receive a response to a second scene of the computer game from the user of the second communication terminal;
combine the response from the user of the first communication terminal and the response from the user of the second communication terminal to generate a composite response to the computer game; and
determine whether the composite response to the computer game matches a predefined response to the computer game.

12. A device, comprising:
a computer processor for executing computer program modules; and
a non-transitory computer readable storage medium storing computer program modules executable to perform steps comprising:
initiating, by the device, a video call between the device and a communication terminal;
receiving a predefined set of rules associated with a computer game played between a user of the device and a user of the communication terminal;
capturing description of a plurality of game scenes of the computer game provided by the user of the device;
generating multimedia description data at the device based on the description of the plurality of game scenes; and
determining whether the user of the device violates at least one of the predefined set of rules in response to the generated multimedia description data.

13. The device of claim 12, wherein each of the plurality of game scenes has at least one associated predefined rule selected from the predefined set of rules associated with the computer game.

14. The device of claim 12, wherein the computer program modules further executed to perform steps comprising establishing a game channel between the device and the communication terminal, the game channel associated with the video call between the device and the communication terminal.

15. The device of claim 12, wherein the computer program modules further executed to perform steps comprising:
responsive to a determination that the user of the device does not violate the predefined set of rules:
transmitting the multimedia description data to the communication terminal;
receiving a response to the multimedia description data from the communication terminal; and
determining whether the response from the communication terminal matches a predefined response, the predefined response describing an object of the computer game.

16. The device of claim 15, wherein the computer program modules further executed to perform steps comprising:
responsive to a determination that the response matches the predefined response, displaying the determination on the device.

17. The device of claim 12, wherein the computer program modules further executed to perform steps comprising:
responsive to a determination that the user of the device violates the predefined set of rules:
generating at least one description of the violation;
displaying the description of the violation on the device;
transmitting the description of the violation to the communication terminal, wherein the communication terminal is adapted to display the description of the violation on the communication terminal; and
terminating the computer game on the device.

18. The device of claim 12, wherein the predefined set of rules associated with a computer game describes a plurality of conditions under which a user playing the computer game violates the predefined set of rules.

19. The device of claim 12, wherein capturing description of a plurality of game scenes of the computer game provided by the user of the device comprises:
capturing one or more body movements of the user of the device;
capturing one or more facial expressions of the user of the device; and
recording voices of the device;
wherein the captured body movements, facial expressions and voices of the user of the device are associated with the computer game.

20. The device of claim 12, wherein violations of the predefined set of rules comprises at least one of the following:
showing a picture of an object of the computer game;
showing an real substance of an object of the computer game; and
pronouncing the name of an object of the computer game.

21. The device of claim 12, wherein the computer program modules further executed to perform steps comprising:
generating a response to a first scene of the computer game by the user of the device;
receiving a response to a second scene of the computer game from the user of the communication terminal;
combining the response from the user of the device and the response from the user of the communication terminal to generate a composite response to the computer game; and
determining whether the composite response to the computer game matches a predefined response to the computer game.

22. The device of claim 12, wherein the computer program modules further executed to perform steps comprising:
generating a response to a first scene of the computer game by the user of the device; and
providing the response to the first scene to a game server, wherein the game server is adapted to:
receive a response to a second scene of the computer game from the user of the communication terminal;
combine the response from the user of the device and the response from the user of the communication terminal to generate a composite response to the computer game; and
determine whether the composite response to the computer game matches a predefined response to the computer game.

23. A non-transitory computer readable medium storing executable computer program instructions, the computer program instructions comprising instructions that when executed cause a computer processor to:
initiate, by a first communication terminal, a video call between the first communication terminal and a second communication terminal;
receive a predefined set of rules associated with a computer game played between a user of the first communication terminal and a user of the second communication terminal;
capture description of a plurality of game scenes of the computer game provided by the user of the first communication terminal;
generate multimedia description data at the first communication terminal based on the description of the plurality of game scenes; and
determine whether the user of the first communication terminal violates at least one of the predefined set of rules in response to the generated multimedia description data.

24. The computer readable medium of claim 23, wherein each of the plurality of game scenes has at least one associated predefined rule selected from the predefined set of rules associated with the computer game.

25. The computer readable medium of claim 23, further comprising computer program instructions that when executed cause the computer processor to:
responsive to a determination that the user of the first communication terminal does not violate the predefined set of rules:
transmit the multimedia description data to the second communication terminal;
receive a response to the multimedia description data from the second communication terminal; and
determine whether the response from the second communication terminal matches a predefined response, the predefined response describing an object of the computer game.

26. The computer readable medium of claim 23, further comprising computer program instructions that when executed cause the computer processor to:
responsive to a determination that the user of the first communication terminal violates the predefined set of rules:
generate at least one description of the violation;
display the description of the violation on the first communication terminal;
transmit the description of the violation to the second communication terminal, wherein the second communication terminal is adapted to display the description of the violation on the second communication terminal; and
terminate the computer game on the first communication terminal.

27. The computer readable medium of claim 23, wherein the predefined set of rules associated with a computer game describes a plurality of conditions under which a user playing the computer game violates the predefined set of rules.

28. The computer readable medium of claim 23, wherein the computer program instructions for capturing description of a plurality of game scenes of the computer game provided by the user of the first communication terminal comprise instructions that when executed cause the computer processor to:
capture one or more body movements of the user of the first communication terminal;
capture one or more facial expressions of the user of the first communication terminal; and
record voices of the first communication terminal;
wherein the captured body movements, facial expressions and voices of the user of the first communication terminal are associated with the computer game.

29. The computer readable medium of claim 23, further comprising computer program instructions that when executed cause the computer processor to:
generate a response to a first scene of the computer game by the user of the first communication terminal;
receive a response to a second scene of the computer game from the user of the second communication terminal;
combine the response from the user of the first communication terminal and the response from the user of the second communication terminal to generate a composite response to the computer game; and
determine whether the composite response to the computer game matches a predefined response to the computer game.

30. The computer readable medium of claim 23, further comprising computer program instructions that when executed cause the computer processor to:
generate a response to a first scene of the computer game by the user of the first communication terminal; and
provide the response to the first scene to a game server, wherein the game server is adapted to:
receive a response to a second scene of the computer game from the user of the second communication terminal;
combine the response from the user of the first communication terminal and the response from the user of the second communication terminal to generate a composite response to the computer game; and
determine whether the composite response to the computer game matches a predefined response to the computer game.
